(19) United States
(12) Patent Application Publication
(10) Pub. No.: US 2009/0155078 A1
(43) Pub. Date: Jun. 18, 2009

(54) Brazed torque converter pump hub assembly and method of fabrication

(75) Inventors: Gregory A. Heeke, Wooster, OH (US); Bhaskar Marathe, Copley, OH (US); Bruno Mueller, Sasbach (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/316,229

(22) Filed: Dec. 10, 2008

Related U.S. Application Data
(60) Provisional application No. 61/008,049, filed on Dec. 18, 2007.

(51) Int. Cl. F16H 41/28; B21D 53/78

(52) U.S. Cl. 416/197 C; 29/889.6

(57) ABSTRACT

The invention relates to a more efficient and cost effective method of bonding pump blades and a pump hub to an impeller of a torque converter by the steps of initially assembling the pump blades and the pump hub adjacent and in close proximity to the impeller and bonding the pump hub and the pump blades to the impeller simultaneously while also eliminating the potential for surface defects through multiple heating steps. The invention includes the more efficient methods of manufacturing, but also the brazed/welded assemblies and torque converters comprising the assemblies.

### CROSS-REFERENCE TO RELATED APPLICATIONS

This application claims the benefit under 35 U.S.C. §119(e) of U.S. Provisional Application No. 61/008,049 filed on Dec. 18, 2007 which application is incorporated herein by reference.

### FIELD OF THE INVENTION

The present invention relates generally to more efficient, and therefore, more economic methods in the fabrication of torque converters for motorized vehicles which eliminate multiple brazing/welding steps in sub-assembly operations.

### BACKGROUND OF THE INVENTION

Torque converters are positioned between the engine and transmission case of motorized vehicles. They play an important role by controlling on/off power from the engine to the rest of the drive train. In addition, they provide torque multiplication, dampen engine vibration and assure smooth start-ups and speed changes.

A typical torque converter assembly comprises as principal components, an impeller or pump, a turbine and a stator positioned between the turbine and pump. The turbine and pump are seated in opposing shells and rotate therewith. The torque converter pump is connected to the engine, and as the pump rotates energy is transmitted to the turbine by forcing fluid against turbine blades causing their rotation. The turbine, which is connected to the transmission, transmits torque to vehicle wheels. The torque converter pump also turns the transmission oil pump. The stator positioned between the turbine and impeller operates to redirect the flow of fluid allowing the pump to rotate with less torque, so as to provide torque multiplication.

In the assembly of torque converters it has been the practice to join fixtured pump blades to the impeller by means of a furnace brazing operation. Subsequent to brazing of the pump blades to the impeller, a pump hub would be joined to the impeller-blade assembly in a second operation by means of MIG (metal inert gas) welding. This second welding operation, however, requires the additional step of first refixturing the hub and impeller in a jig, followed by welding. But, in addition to the extra refixturing step, it was found that the practice of MIG welding introduces a large heat affected zone which can cause stress risers in the impeller and hub that can lead to cracking.

Accordingly, there is a need for an improved method which allows for a more economic consolidated assembly operation wherein the pump blades and pump hub of a torque converter are simultaneously joined to the impeller, thereby eliminating multiple independent processing steps and the potential for generating surface imperfections in the impeller and hub.

### BRIEF SUMMARY OF THE INVENTION

It is therefore a principal object of the invention to provide a more efficient and cost effective method of bonding pump blades and a pump hub to an impeller of a torque converter by the steps of initially assembling the pump blades and the pump hub adjacent and in close proximity to the impeller and bonding the pump hub and the pump blades to the impeller simultaneously while also eliminating the potential for surface defects through multiple heating steps.

Accordingly, the method of the present invention effectively eliminates the need for a second bonding step, such as by MIG (metal inert gas) welding. That is to say, the method of the present invention removes the welding step currently required to bond the pump hub to the impeller, and therefore, also eliminates the task of refixturing the hub and impeller followed by a second welding operation.

Methods of the invention also provide for the step of mounting and positioning the pump blades and the pump hub adjacent to the impeller with jigging means, such as an appropriate fixture as disclosed in further detail below.

It is yet a further object of the invention to provide a method, wherein the step of bonding the pump blades and pump hub to the impeller simultaneously is performed by means of welding or brazing.

Brazing is generally intended to relate to processes wherein parts of the torque converter, i.e., the pump hub, blades and impeller, are joined by heating to the melting point of the filler metal (paste) being used. This allows the molten filler metal to flow via capillary action into the close fitting surfaces of the joint. This is normally performed in a furnace, i.e., brazing furnace. Generally, the base metal does not melt, but may alloy with the molten filler metal. Welding, on the other hand, forms a metallurgical joint in much the same way as brazing, however, with welding processes filler metals flow at generally higher temperatures than the brazing filler metals, but at or just below the melting point of the base metals being joined.

It is still a further object of the invention to provide joints of appropriate design that are capable of providing greater strength than the base material.

It is yet a further object of the invention to provide more reliable torque converters comprising the pump blades, pump hub and impeller sub-assemblies which are brazed according to the foregoing methods.

These and other features and advantages will become more apparent from a reading of the detailed description of the invention below.

### BRIEF DESCRIPTION OF THE SEVERAL VIEWS OF THE DRAWING

The nature and mode of operation of the invention will now be more fully described in the following detailed description of the invention taken with the accompanying drawing Figure, in which:

FIG. 1 is a side sectional view of one embodiment of the invention mounted on a suitable jig for brazing wherein pump blades and pump hub having a lap seal arrangement are bonded to the impeller in a single brazing step.

### DETAILED DESCRIPTION OF THE INVENTION

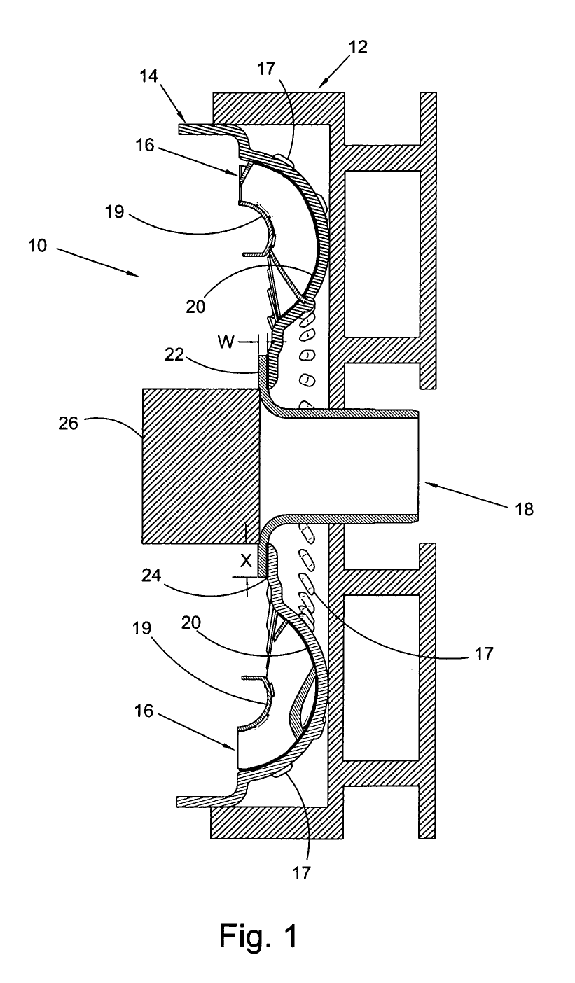

Turning first to FIG. 1 of the drawings there is shown an impeller assembly 10 mounted in a brazing fixture or jig 12 suitable for holding impeller 14, a plurality of pump blades 16 and a flanged pump hub 18 for brazing in a single operation. The fixture or jig serves two purposes: firstly to elevate the workpiece so the pump hub can protrude downwardly without contacting the furnace belt during brazing, and secondly, to center the hub in the impeller.

The assembly is prepared for brazing by initially placing pump blades 16 formed with tabs (not shown) on the outside edge for fitting into depressions 17 formed in the inside wall of impeller 14. In addition, pump blades 16 have tabs on the inside edge that fit into slots (not shown) in core ring 19 of the impeller. After positioning the blades in the impeller depressions 17 and slots of the core ring 19 the tabs passing through the core ring are bent locking the blades in place. A paste, such as a copper-based furnace brazing paste, commercially available under the Cubond® trademark from SCM Metal Products, Inc., of N. Carolina is then deposited where each blade meets the ID of the shell of the impeller and the OD of the core ring. The paste is conveniently deposited as dabs at each of the tabs using a commercially available paste gun having a plurality of tips so as the impeller shell is rotated dabs of the paste are deposited at tab areas 20 where the tab depressions 17 are located and at the OD of the blades where the tabs have engaged with slots in core ring 19.

Prior to brazing the assembly, the pump hub 18 having flange 22 is coated with a layer of the brazing paste 24 applied to the outer edge of the flange before placement of the hub into the central opening of the impeller for engagement therewith. After placement, a weight 26 is applied across the inner edge of pump hub 18 holding the hub in a compressed arrangement with the impeller during brazing.

The assembly positioned on jig 12 is then placed into a continuous belt brazing furnace of conventional design (not shown) where it is retained during the furnace heating cycle. This causes the vehicle in the brazing paste to evaporate; the filler metal then melts filling joint areas, which then solidifies upon furnace cooling to form a strong, leak-free multipart assembly in a single welding/brazing operation.

After the assembly leaves the furnace and has sufficient time to cool the assembly is removed from the fixture. The hub braze is inspected, and the fixture reused for another assembly. The hub is then machined to achieve dimensional requirements, as well as surface finish and hardness. The process results in a strong economical joint between the hub and impeller.

The invention of simultaneously utilizing furnace brazing operations for eliminating processing steps of the pump sub-assembly also provides for joints possessing greater strength in the overlap areas. That is to say, when the joint is properly designed according to the present invention it will possess greater strength than the base material. In this regard, referring back to FIG. 1 to calculate the correct length of the lap (X) between two overlapping surfaces, in this case the flange joint of the pump hub (X) and the impeller for greater joint strength the following formula may be applied:

$$X = \frac{TW}{CL}$$

wherein (T) is the tensile strength of the weakest member, namely the pump hub and the length of the lap (X), and (W) is the thickness of the base metal. C is a joint integrity factor of 0.8 and L is the linear shear strength of brazed filler metal according to the invention. Thus, solving for X will provide artisans with the length of the desired overlap for maximizing the strength of the joint.

We claim:

1. A method of bonding pump blades and a pump hub to an impeller of a torque converter, which comprises the steps of assembling by positioning said pump blades and said pump hub adjacent to said impeller, and bonding said pump hub and said pump blades to said impeller simultaneously, said method eliminating the need for a second bonding step.

2. The method according to claim 1, wherein said step of positioning said pump blades and said pump hub adjacent to said impeller is performed with the aid of means for jigging.

3. The method according to claim 2, wherein said means for jigging comprises a fixture.

4. The method according to claim 2, wherein said step of bonding said pump blades and said pump hub to said impeller simultaneously is performed by welding or brazing.

5. The method according to claim 1, wherein said step of bonding said pump blades and said pump hub to said impeller simultaneously is by brazing.

6. The method according to claim 5, wherein said brazing step is by furnace brazing.

7. The method according to claim 5, wherein a lap joint is formed in said steps of assembling and bonding said pump hub to said impeller.

8. An assembly made according to the method of claim 1.

9. An assembly made according to the method of claim 2.

10. An assembly made according to the method of claim 3.

11. An assembly made according to the method of claim 4.

12. An assembly made according to the method of claim 5.

13. An assembly made according to the method of claim 6.

14. An assembly made according to the method of claim 7.

15. A torque converter comprising the assembly of claim 10.

16. A torque converter comprising the assembly of claim 11.

17. A torque converter comprising the assembly of claim 12.

18. A torque converter comprising the assembly of claim 13.

19. A torque converter comprising the assembly of claim 14.

20. A torque converter comprising the assembly of claim 15.

21. A torque converter comprising the assembly of claim 16.
